(19) United States
(12) Patent Application Publication
(10) Pub. No.: US 2019/0176254 A1
(43) Pub. Date: Jun. 13, 2019

(54) METHOD AND DEVICE FOR HARD-FINE MACHINING INTERNALLY TOOTHED GEARWHEELS BY MEANS OF A TOOTHED HONING MACHINE

(71) Applicant: AUDI AG, Ingolstadt (DE)

(72) Inventors: Markus HEILMANN, Garching (DE); Thomas SCHIMMER, Ingolstadt (DE); Philipp BURATOWSKI, Ingolstadt (DE)

(73) Assignee: AUDI AG, Ingolstadt (DE)

(21) Appl. No.: 16/310,531

(22) PCT Filed: Jul. 10, 2017
(86) PCT No.: PCT/EP2017/000811

§ 371 Date: Dec. 17, 2018

(30) Foreign Application Priority Data
Aug. 3, 2016 (DE) 10 2016 009 469.9

(51) Int. Cl. B23F 19/05; B23F 23/12; B24B 53/075

(52) U.S. Cl. CPC B23F 19/057; B24B 53/075; B23F 23/1231

(57) ABSTRACT

A method for machining an internally toothed workpiece, in which the workpiece is clamped into a toothed honing machine, and in which at least one tool that is at least partially made of a high-hardness cutting material is guided along respective teeth of the internally toothed workpiece, in order to carry out hard-fine machining of the teeth of the internally toothed workpiece.

The present invention relates to a method for machining an internally toothed workpiece as well as a tool and a toothed honing machine.

Internally toothed hollow gears, i.e., gearwheels with an internal toothing, are used in particular in gearings such as planetary gears. An internal toothing of a gearwheel traditionally can only be raised with very great expense to the level of quality that is typical of gearwheels with external toothing. The prior art is to soft machine the internal toothing of a respective gearwheel and then to harden it. No hard-fine machining is produced, especially in large series fabrication, since a hard-fine machining is associated with tremendously high costs.

Lack of a hard-fine machining results in a poorer quality when compared to externally toothed gearwheels, i.e., it results in less wear and possibly increased noise emission during operation, such as in a transmission. Common methods for hard-fine machining of internally toothed gearwheels, such as profile grinding, are associated with enormous costs.

German publication DE 10 2012 108 717 A1 describes a dressing method with a geometrically defined cutting edge of a honing ring.

German publication DE 196 25 285 A1 discloses a machining of a hollow gear with a chipless forming method to smooth out the tooth flanks.

A machine technique making it possible, with the aid of a guide mechanism, to start the machining of a gearwheel already at a working speed and to carry out a single-flank machining of the gearwheel is disclosed in German publication DE 350 19 35 C1.

Against this background, a method is proposed for machining an internally toothed workpiece, in which the workpiece is clamped into a toothed honing machine, and in which at least one tool that is at least partially made of a high-hardness cutting material is guided along respective teeth of the internally toothed workpiece in order to carry out hard-fine machining of the teeth of the internally toothed workpiece.

The proposed method serves, in particular, for the hard-fine machining of a hardened internally toothed gearwheel in a rapidly occurring process, which is also suitable for use in large series fabrication. For this, it is proposed to install a respective internally toothed gearwheel or hollow gear in a toothed honing machine, especially in the place of a honing ring, and to guide at least one tool, which is composed at least partly of a high-hardness cutting material, along respective teeth of the gearwheel, so that the at least one tool, during its movement along the teeth of the gearwheel, penetrates into respective gaps between the teeth, and a removal of material occurs in this process from the respective flanks and/or possibly from the tooth roots of the teeth.

It is provided, in particular, that a toothed honing machine is used to carry out the proposed method, said machine moving the at least one tool provided according to the invention with a machine kinematics that is provided for a method of power honing, so that no new movement sequence needs to be set up on the toothed honing machine for the method according to the invention after one power honing pass.

According to the proposed method, it is provided, in particular, that an internally toothed gearwheel is machined in a chip removing process with geometrically undefined cutting edge.

In one possible embodiment of the proposed method, it is provided that the high-hardness cutting material is chosen to be polycrystalline diamond, for example, or especially cubic boron nitride (cBN).

In another possible embodiment of the proposed method, it is provided that the at least one tool is chosen to be an externally toothed gearwheel-shaped tool, wherein the at least one tool is broader than the workpiece by a multiple, especially a twofold or threefold factor.

By means of a tool whose dimensions exceed the dimensions of the respective workpiece, especially in its width, it is possible to displace the tool on the workpiece in such a way that the tool contacts and accordingly machines the workpiece by different regions. For this, the tool may be broader than the workpiece and accordingly be displaced with respect to the workpiece in the axial direction, especially along an axis running horizontally or vertically through a center point of the tool, or by way of modifying a particular axis intersection angle relative to the workpiece, in each case depending on the desired process sequence, in single-axis or multiple-axis synchronized movement.

In one possible embodiment of the proposed method, it is provided that an axis intersection angle of the at least one tool with the workpiece is modified so that the workpiece contacts the at least one tool at a predetermined point.

In another possible embodiment of the proposed method, it is provided that the tool is displaced axially along an axis running horizontally or vertically through a center point of the tool, so that the workpiece contacts the at least one tool at a predetermined point.

By means of an axial displacement of a respective tool, i.e., a displacement along an axis running vertically or horizontally through a center point of the tool, for example, a contact site of the tool with the workpiece can be established, depending on the relative orientation of the tool to the workpiece. This means, for example, that the tool as a whole is displaced relative to the workpiece, in order to establish a contact site of the tool with the workpiece.

In one possible embodiment of the proposed method, it is provided that the at least one tool has regions with different surface properties along a longitudinal axis of the at least one tool, and the at least one tool is moved along the workpiece in a predetermined movement sequence in order to make contact with and accordingly machine the workpiece in succession with respective regions of the at least one tool having different surface properties. The machining may be conducted in a continuous movement as well as in an interrupted cut. In particular, in this case, the machining may be used to improve the surface properties of the workpiece.

In order to machine a respective workpiece in a single pass or with one machine and a particular tool so that the workpiece is ready for use after the machining pass, the tool may comprise multiple regions with different roughness, for example, which are brought successively or alternatingly into contact with the workpiece by displacing the tool, in particular, axially, i.e., along an axis running vertically or horizontally through a center point of the tool, relative to the workpiece, or by changing an axis intersection angle of the tool relative to the workpiece. This means that such a tool can be used to carry out at first a roughing and then a finishing process.

It is further conceivable that the at least one tool provided according to the invention comprises multiple regions of the same roughness and the at least one tool is moved in such a way that a contact site of the at least one tool with the workpiece is changed, so that the at least one tool over time makes contact with the workpiece at a plurality of sites and individual sites or regions of the at least one tool are relieved of stress, so that the service life of the at least one tool is increased when compared to a method with a permanent contacting at one site or in one region.

It is further conceivable, in one embodiment of the proposed method, to use at least one dressable tool, which is to be dressed, i.e., profiled and/or sharpened, by means of a dressing tool. Of course, it is conceivable in this case that the at least one tool is dressed region by region while the at least one tool is displaced along a respective workpiece, in order to establish a respective contact site between the at least one tool and the workpiece and make possible a parallel dressing, especially a dressing in parallel with the main operating phase.

By the term “dressing” is meant, in the context of the present invention, a process in which a tool is reprofiled or recalibrated.

Moreover, the present invention relates to a tool for the machining of an internally toothed workpiece, wherein the tool is at least partially made of a high-hardness cutting material.

The proposed tool serves, in particular, for carrying out the proposed method.

In one possible embodiment of the proposed tool, it is provided that the tool is configured to machine, respectively, one tooth flank of a tooth of the internally toothed workpiece or two tooth flanks, and/or one tooth root of respective teeth bordering on a recess of the internally toothed workpiece, at the same time as the tool is moved along the internally toothed workpiece.

The proposed tool, in particular, has the form of an externally toothed gearwheel.

Moreover, the present invention relates to a toothed honing machine with a mount for a workpiece and a dressing tool, wherein the dressing tool is configured to dress, at least in regions, at least one tool that is at least partially made of a high-hardness cutting material, said tool to be moved on the inside along a workpiece that is to be introduced into the mount.

The proposed toothed honing machine serves, in particular, for carrying out the proposed method.

By means of a dressing tool, such as a dressing roller, which is arranged, in particular, movably on the toothed honing machine according to the invention, the tool proposed according to the invention can be dressed efficiently and without changing the tool. The dressing tool, in particular, may be shaped like a grinding worm during generating gear grinding, in order to make possible a quick dressing in a continuous process.

It is conceivable that the tool proposed according to the invention is dressed during operation, i.e., during a movement along a respective workpiece, or during an intermission, i.e., in an operating phase in which the tool is moved into a dressing position.

In one possible embodiment of the proposed toothed honing machine, it is provided that the mount is a mount in which a honing ring is to be inserted for the machining of an externally toothed workpiece in one honing mode of the toothed honing machine.

It is provided, in particular, that a toothed honing machine, which is configured for the honing of an externally toothed gearwheel, is reconfigured into one possible embodiment of the proposed toothed honing machine, by replacing one honing ring of the toothed honing machine with a workpiece and by positioning one possible embodiment of the tool according to the invention on the workpiece.

Further advantages and embodiments of the invention will emerge from the description and the accompanying drawing.

Of course, the above-mentioned features and the following features yet to be explained can be used not only in the particular indicated combination, but also in other combinations or standing alone, without leaving the scope of the present invention.

The invention is represented schematically in the drawing on the basis of embodiments and shall be described schematically and at length with reference to the drawing.

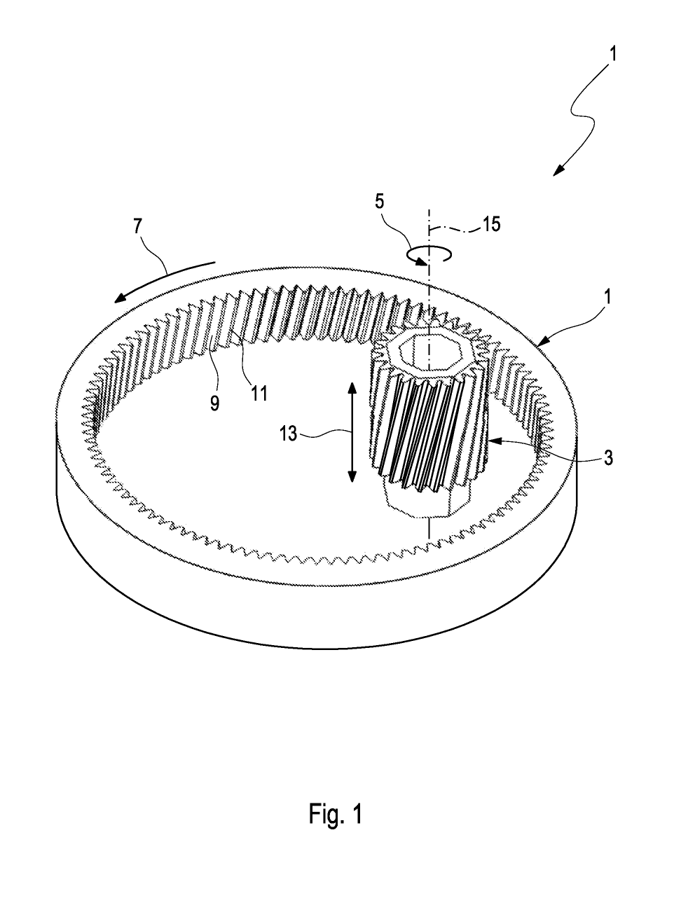

FIG. 1 shows one possible embodiment of a tool configured according to the invention for carrying out one possible embodiment of the proposed method.

FIG. 1 shows a workpiece 1 in the form of an internally toothed gearwheel. The workpiece 1 has been clamped in a toothed honing machine, not represented, in the place where a honing ring is traditionally clamped when the toothed honing machine is used for honing.

In order to hard-fine machine respective teeth, i.e., especially tooth flanks and/or tooth roots of the workpiece 1, it is proposed to install a tool 3 at a place of the toothed honing machine where a workpiece is traditionally clamped when the toothed honing machine is used for honing. This means that the tool 3 and the workpiece 1 are arranged and rotate at an axis intersection angle so that a removal of material occurs on respective teeth of the workpiece 1. The tool 3 can be moved along an axis 15 of the tool 3, as indicated by arrow 13. The workpiece 1 itself may also be moved, as suggested by arrow 7, in order to assist the rolling movement of the tool 3 against the teeth.

The workpiece 1 comprises tooth flanks 9 at respective teeth, said flanks composed of hardened material. In order to fine machine the tooth flanks 9, the tool 3 has a coating of a high-hardness or high-strength cutting material, such as diamond or boron nitride.

In the present instance, the tool 3 is configured for a single-flank contact, i.e., a machining of only one tooth flank 9 per movement of the tool 3. Of course, the tool 3 may also be configured to enable a machining of two tooth flanks 9 and/or one tooth root 11 of the workpiece 1 per movement, i.e., upon entering into a recess formed between two teeth.

1-13. (canceled)

14. A method for machining an internally toothed workpiece, comprising:
the workpiece is clamped into a mount of a toothed honing machine, said mount being provided for the insertion of a honing ring, and at least one tool that is at least partially made of a high-hardness cutting material is guided along respective teeth of the internally toothed workpiece, in order to carry out hard-fine machining of the teeth of the internally toothed workpiece.

15. The method as claimed in claim 14, wherein an internally toothed gearwheel with hardened tooth flanks is chosen as the workpiece.

16. The method as claimed in claim 14, wherein polycrystalline diamond, especially a ceramically bonded diamond is chosen as the high-hardness cutting material.

17. The method as claimed in claim 14, wherein boron nitride, especially cubic ceramically bonded boron nitride is chosen as the high-hardness cutting material.

18. The method as claimed in claim 14, wherein at least one externally toothed gearwheel-shaped tool is chosen as the at least one tool, wherein the at least one tool is broader than the workpiece by a multiple, especially a twofold or a threefold factor.

19. The method as claimed in claim 18, wherein an axis intersection angle of the at least one tool with the workpiece is modified, so that the workpiece contacts the at least one tool at a predetermined point.

20. The method as claimed in claim 18, wherein the tool is displaced axially along an axis running horizontally or vertically through a center point of the tool, so that the workpiece contacts the at least one tool at a predetermined point.

21. The method as claimed in claim 5, wherein the at least one tool has regions with different surface properties along a longitudinal axis of the tool, and in which the at least one tool is moved along the workpiece in a predetermined movement sequence, in order to make contact with and accordingly to machine the workpiece in succession with respective regions of the at least one tool having different surface properties.

22. A tool for the machining of an internally toothed workpiece, comprising:
the tool is at least partially made of a high-hardness cutting material and has different regions with different surface properties along a longitudinal axis of the tool.

23. The tool as claimed in claim 22, wherein the tool is configured to machine respectively one tooth flank of a tooth of the internally toothed workpiece, or two tooth flanks, and/or one tooth root of respective teeth bordering on a recess of the internally toothed workpiece at the same time, while the tool is moved along the internally toothed workpiece.

24. The tool as claimed in claim 22, wherein the tool is configured in a dressable manner.

25. A toothed honing machine comprising:
a mount for a workpiece and a helical-shaped dressing tool that works in a continuous process, wherein the dressing tool is configured to dress, at least in regions, at least one tool that is at least partially made of a high-hardness cutting material, said tool to be moved on the inside along an internally toothed workpiece to be introduced in in the mount.

26. The toothed honing machine as claimed in claim 25, wherein the mount is a mount in which, in a honing mode of the toothed honing machine, a honing ring is to be inserted for the machining of an externally toothed workpiece, and in which the internally toothed workpiece is inserted instead of the honing ring.
